(19) United States
(12) Patent Application Publication
(10) Pub. No.: US 2012/0015283 A1
(43) Pub. Date: Jan. 19, 2012

(54) COMPOSITE GASKET FOR FUEL CELL STACK

(75) Inventor: Suk-Yal Cha, Fremont, CA (US)

(73) Assignee: OORJA PROTONICS INC., Fremont, CA (US)

(21) Appl. No.: 13/182,442

(22) Filed: Jul. 13, 2011

Related U.S. Application Data
(60) Provisional application No. 61/364,237, filed on Jul. 14, 2010.

(51) Int. Cl. H01M 8/04; H01M 8/10; H01M 2/16

(52) U.S. Cl. 429/516

(57) ABSTRACT

A composite gasket to provide sealing and to control a swelling of at least a plurality of gas diffusion layers in a fuel cell includes a first incompressible layer provided near an anode flow field, a second incompressible layer provided near a cathode flow field. Further, the composite gasket includes a first elastomeric layer provided in between the first incompressible layer and the anode flow field and a second elastomeric layer provided between the second incompressible layer and the cathode flow field.

### CROSS REFERENCE TO RELATED APPLICATION

This application claims priority to U.S. Provisional Application No. 61/364,237 filed on Jul. 14, 2010, the complete disclosure of which is incorporated fully herein by reference.

### TECHNICAL FIELD

The embodiments herein generally relate to fuel cells, and, more particularly, to a gasket that allows sealing, consistent control of compression, and improvement of durability for fuel cell stacks.

### BACKGROUND

A fuel cell provides direct current electricity from two electrochemical reactions. The electrochemical reactions occur at electrodes to which reactants are fed. For example, in a direct methanol fuel cell (DMFC), a negative electrode (i.e., anode) is maintained by supplying a fuel such as methanol, whereas a positive electrode (i.e., cathode) is maintained by supplying oxygen or air. When providing a current, methanol is electrochemically oxidized at an anode electro-catalyst to produce electrons, which travel through an external circuit to a cathode electro-catalyst where the electrons are consumed together with oxygen in a reduction reaction. A circuit is maintained within the DMFC by the conduction of protons in an electrolyte.

A fuel cell stack typically includes a series of fuel cells. Each cell includes a pair of anode and cathode. A voltage across each cell is determined by the type of electrochemical reaction occurring in the cell. For example, for a typical single DMFC, the voltage can vary from 0 V to 0.9 V, depending on a current being generated. The current being generated in the cell depends on the operating condition and design of the cell, such as electro-catalyst composition/distribution and active surface area of a membrane electrode assembly (MEA), characteristics of a gas diffusion layer (GDL), flow field design of anode and cathode bipolar plates, cell temperature, reactant concentration, reactant flow and pressure distribution, reaction by-product removal, and so forth. The reaction area of a cell, number of cells in series, and the type of electrochemical reaction in the fuel cell stack determine a current and hence a power supplied by the fuel cell stack. For example, typical power for a DMFC stack can range from a few watts to several kilowatts.

A fuel cell system typically integrates a fuel cell stack with different subsystems for the management of water, fuel, air, humidification, and thermal condition. These subsystems are sometimes collectively referred to as a balance of the plant (BOP). The interface between the fuel cell stack and the BOP is referred to as a stack manifold. The stack manifold serves as a conduit for bi-directional flow distribution between the BOP and the fuel cell stack. Conduits for bi-directional fluid flows between the stack manifold and individual cells are called headers and are part of anode and cathode plate design.

Further, it is desirable for a volumetric density (e.g., in terms of kilowatts/liter) of a fuel cell stack to be as high as practical, which typically involves a reduction in a stack volume for a particular power delivered by the fuel cell stack. High power (e.g., greater than about 0.5 kilowatts) DMFC stacks typically suffer from mass transport restrictions of anodes and cathodes when operated at higher volumetric densities. In addition, the DMFC stacks can sometimes suffer from irreversible cathode damage arising from gas diffusion layer over-compression and silicon oxide deposition on the gas diffusion layer and the flow field plate of cathode side causing mass transport restriction. The effectiveness of the mass transport is typically affected by the degree of compression of the gas diffusion layers, and other characteristics such as porosity and Teflon content. A certain degree of compression is desirable to reduce Ohmic resistances between the anode flow field plate and the cathode flow field plate, the gas diffusion layers, and the catalyst coated membrane. However, too high a compression can crush fibers forming the the gas diffusion layers and close pores through which mass transport occurs which may result in damage of the electrodes.

Therefore, there is a need to develop fuel cells employing a gasket that allows sealing, consistent control of compression, and improvement of durability for fuel cell stacks.

### SUMMARY

In view of the foregoing, an embodiment herein provides a composite gasket to provide sealing and to control a swelling of at least a plurality of gas diffusion layers in a fuel cell includes a first incompressible layer provided near an anode flow field, a second incompressible layer provided near a cathode flow field. Further, the composite gasket includes a first elastomeric layer provided in between the first incompressible layer and the anode flow field and a second elastomeric layer provided between the second incompressible layer and the cathode flow field.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a DMFC fuel cell stack of an embodiment as disclpsed herein;

FIG. 2 illustrates an anode flow fields according to an embodiment as disclosed herein;

FIG. 3 illustrates a cathode flow fields according to an embodiment as disclosed herein;

FIG. 4 illustrates membrane electrode assembly (MEA) stacked up with a composite gasket according to an embodiment as disclosed herein;

FIG. 5 is an enlarged view of the header port and the channel portions of the anode flow field of FIG. 2;

FIG. 6 is an enlarged view of the header port and the channel portions of the cathode flow field of FIG. 3; and

FIG. 7 is an exemplary embodiment which shows the composite gasket provided near the anode flow field of FIG. 5.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

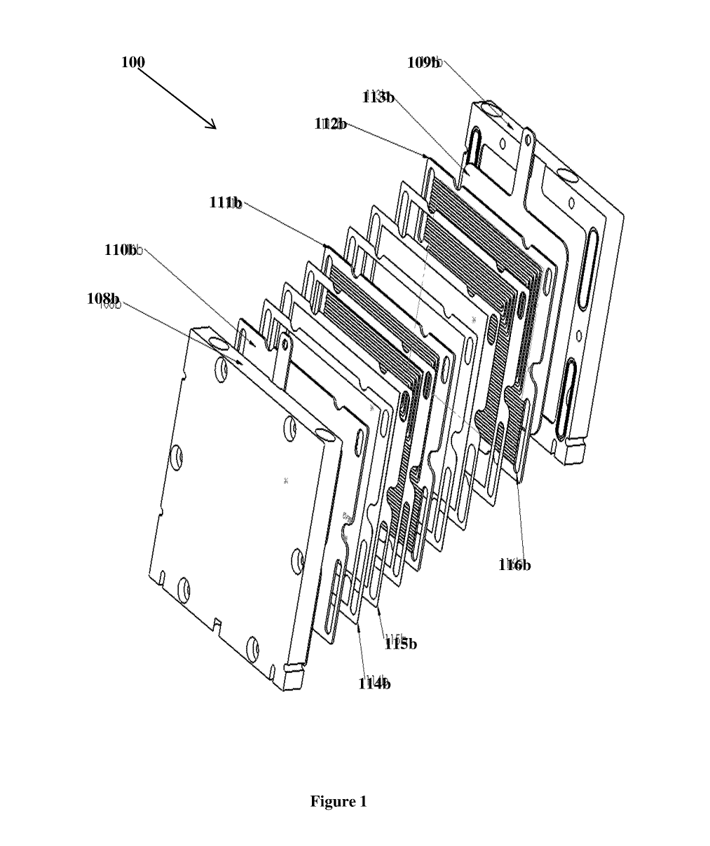

The embodiments herein disclose a composite gasket. Referring now to the drawings, and more particularly to FIGS. 1-7, where similar reference characters denote corresponding features consistently throughout the figures, there are shown embodiments.

FIG. 1 illustrates a fuel cell stack 100 according to an embodiment. The fuel cell stack 100 includes two end plates 108b and 109b having respective manifolds, two monopolar plates 110b and 112b, a variable number of bipolar plates 111b. The fuel cell stack 100 further includes a variable number of membrane electrode assemblies (MEAs) 115b. The membrane electrode assembly 115b is sandwiched between the bipolar plate 111b and the monopolar plate 110b. Further, the fuel cell stack 100 is provided with two current collector plates 113b, and four tie rods (not shown) that hold the stack together and are attached through tie rod holes (not shown). Each of the end plates 108b and 109b are made of fiber-reinforced plastic (e.g., NEMA G-10). It is also within the scope of the invention that the end plates 108b and 109b be made of materials which have properties of mechanical strength and corrosion tolerance.

The bipolar plates 111b are made of graphite. It is to be noted that the bipolar plate 111b can also be made of a metal or an alloy. The bipolar plate 111b has two planar surfaces each of which define flow fields. A flow field on one planar surface facilitates a flow of anode reactants and by-products, and a flow field on the other planar surface facilitates cathode reactants and by-products.

Further, the monopolar plates 110b and 112b are made of graphite. It is to be noted that the monopolar plates 110b and 112bt can be made of a metal or an alloy. Each of the monopolar plates 110b and 112b has a planar surface which defines a flow field therein. Each of the monopolar plates 110b and 112b defining flow field is configured to facilitate flow of reactants and by-products at either anode or cathode. The flow of reactants to the flow fields from the end plates 108b and 109b and the flow of unused reactants and by-products from the flow fields to the end plates 108b and 109b occur through headers 116b defined in the monopolar plates 110b and 112b and the bipolar plates 111b. A pair of anode and cathode flow fields with a MEA sandwiched there between is called a cell. In the illustrated embodiment, the manifolds of the end plates 108b and 109b act as distribution conduits for fluids between the cells in the fuel cell stack 100 and a balance of plant (BOP).

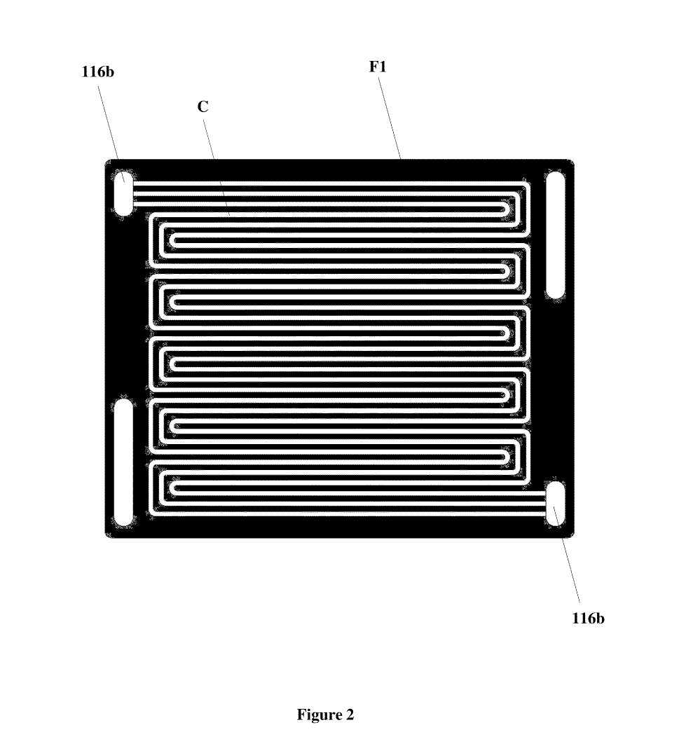

FIG. 2 illustrates an anode flow fields of some embodiments. Fuel, for example, methanol solution, is allowed to pass through the flow field F1 through the header port 116b. The fuel passes through the channels C. In the illustrated embodiments, there are 3 to 6 channels C made available for liquid flow. However, it should be noted that the number of channels C can be kept minimal to ensure adequate flow in each channel, thereby reducing or minimizing fuel flow starvation issues. The fuel flow can be generally upwards, with respect to inlet and outlet ports, further enhancing carbon dioxide removal. Depending on the orientation of the associated plate, the flow in the channels can be generally in an up-sideways orientation.

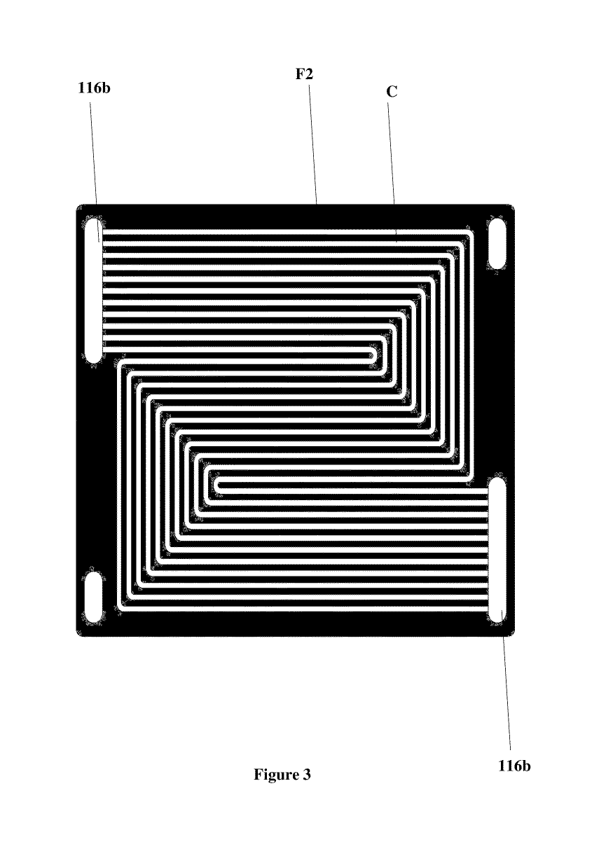

FIG. 3 illustrates a cathode flow fields of some embodiments. Air enters a flow field F2 through the header port 116b. The flow field F2 includes channels C. In the illustrated embodiments, there are 3 to 30 channels C available for air flow. The air flow can be generally downwards, with respect to inlet and outlet ports.

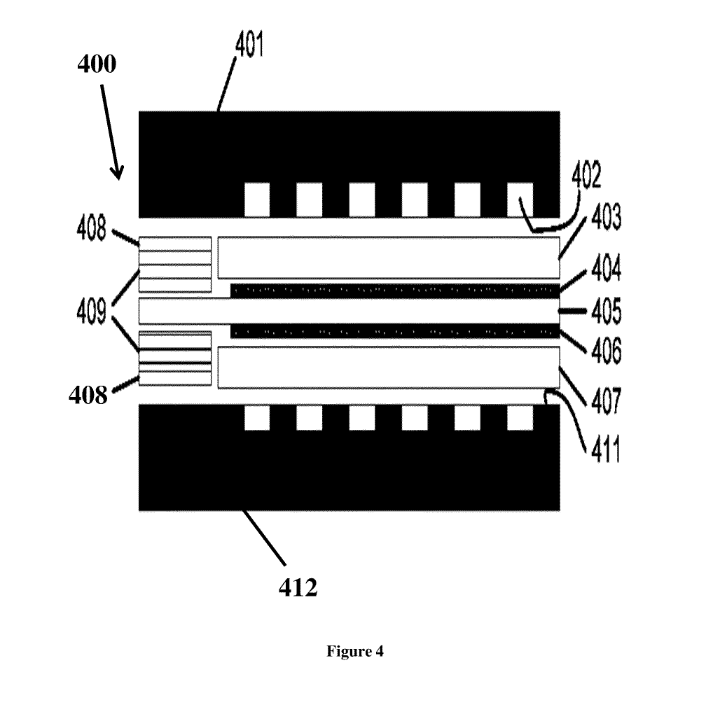

FIG. 4 illustrates membrane electrode assembly MEA stack up with the composite gasket 400 according to an embodiment of the invention. An anode flow field 401 includes a plurality of lands 411 and defining a plurality of channels 402. The anode flow field 401 is configured to be in contact with a first gas diffusion layer (GDL) 403 provided near the anode. The first gas diffusion layer 403 is in contact with a first catalyst layer 404. The first catalyst layer 404 for the anode is interfaced with the proton conductive polymer membrane 405. The proton conductive polymer membrane 405 is a Perfluro sulfonic acid (PFSA) membrane. Similarly, a cathode flow filed 412, includes a plurality of lands 411 defining a plurality of channels 402. The cathode flow field 412 is configured to be in contact with a second gas diffusion layer 407 provided near the cathode. The gas diffusion layer 407 is in contact with a second catalyst layer 406. The second catalyst layer 406 is interfaced with the proton conductive polymer membrane 405.

In general, the assembly of gas diffusion layers (GDLs) 403 and 407, the catalyst layers 404 and 406, and a membrane 405 is referred to as membrane electrode assembly (MEA). The assembly of catalyst layers 404 and 406 and a membrane 405 is referred to as catalyst coated membrane (CCM).

In a fuel cell stack, the entire setup is compressed to a set a compressed height for gas diffusion layers 403 and 407 (GDL). Under compression, each of the gas diffusion layers (GDLs) 403 and 407 are forced towards the CCM and the flow fields 401 and 412. Enhancing the anode-to-cathode land contact ensures lower contact resistance. However, increasing the contact beyond a certain optimum level can sometimes result in higher mass transport losses and higher pressure drops in the channels 402.

The composite gasket 400 is provided for the sealing of reactants from anode and cathode. The composite gasket 400 includes an elastomeric layer 408 and an incompressible layer 409. The elastomeric layer 408 acts as a sealant to seal the surface of the anode and cathode flow fields 401 and 412. A thickness of the elastomeric layer 408 is 10 to 100 microns. Further, a hardness of the elastomeric layer 408 is 10 to 60 Shore A. The elastomeric layer 408 is made of a platinum cured silicone or fluoro silicone or ethylene propylene diene monomer (EPDM). The incompressible layer 409 acts as a shim to control the optimum compression of gas diffusion layers (GDLs) 403 and 407 and to support the elastomeric layer 408. The membrane 405 interfaces with two incompressible layers 409. A thickness of the incompressible layer 409 varies depending on a type of gas diffusion layers (GDLs) 403 and 407. Further, 70 to 95% of thickness of the gas diffusion layers 403 and 407 amounts to a total thicknesses of the composite gasket 400 (the incompressible layer 409 and the elastomeric layer 408). The incompressible layer 409 is made of polyethylene terephthalate referred to as simply polyester. It should be noted that the incompressible layer 409 also be made of other engineering plastics, which are similar materials that have properties of mechanical strength and corrosion tolerance such as polyethylene, polysulfone, polyimide, polypropylene, polyether ether ketone, polycarbonate, polyetherimide. The materials for the incompressible layer 409 should be incompressible under 100° C. and 700 kPa. A portion of the membrane 405 provided near the gasket 400 acts as a sealant to seal incompressible layer 409.

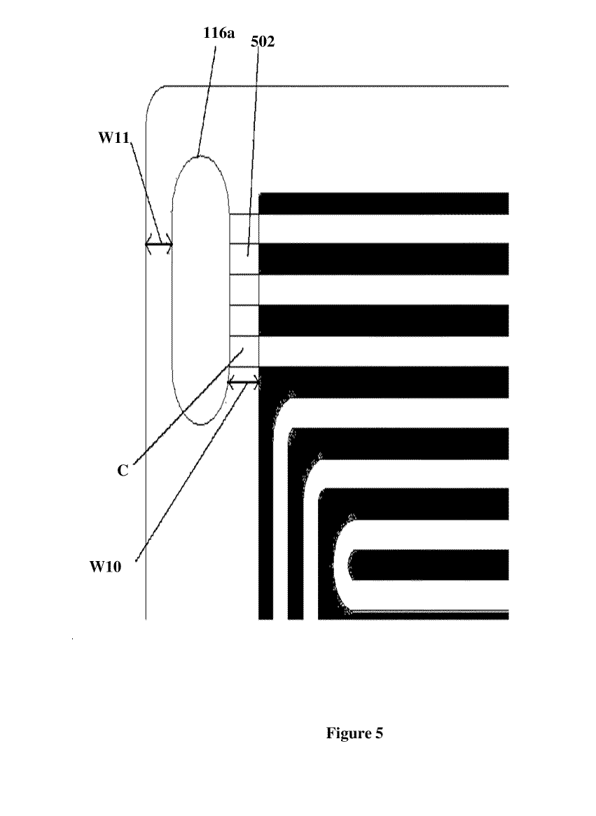

FIG. 5 is an enlarged view of the header port 116a and the channel portions C of the anode flow field of FIG. 2. The portions, which define a first width W10, of the flow field, and that extend towards the header port 116a are to be covered by the composite gasket 400 to ensure proper sealing. Further, the portion, which defines a second width W11 and surrounding the header port 116a is to be covered by the composite gasket 400 to ensure proper sealing.

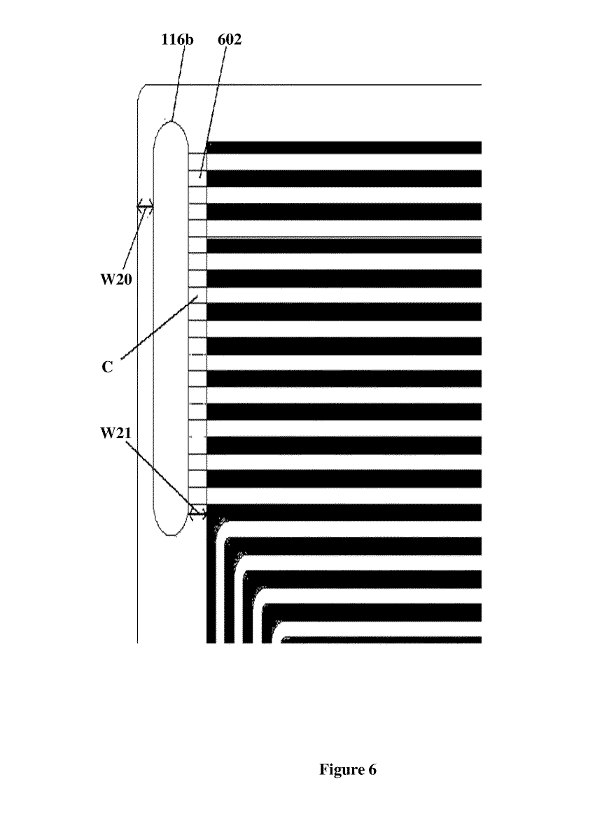

Similarly, as shown in FIG. 6 which is an enlarged view of the header port 116b and the channel C of the cathode flow field of FIG. 3, the portions, which define a first width W20, of the flow field, and that extend towards the header port 116b are to be covered by the composite gasket 400 to ensure proper sealing. Further, the portion, which defines a second width W21 and surrounding the header port 116b is to be covered by the composite gasket 400 to ensure proper sealing.

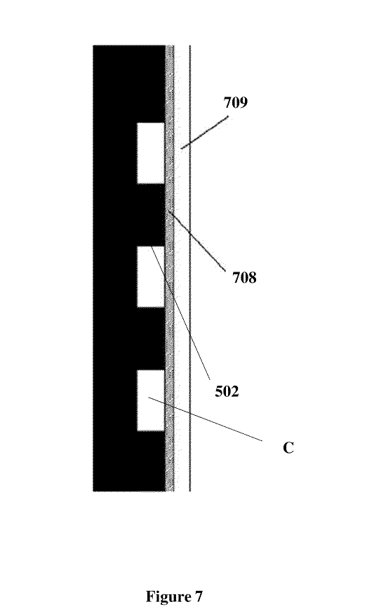

FIG. 7 is an exemplary embodiment which shows the composite gasket 400 provided near the anode flow field of FIG. 5. In FIG. 7, the elastomeric layer 708 is provided over the channels C. The elastomeric layer 708 is in direct contact with the lands 502. Further, the incompressible layer 709 is provided on the elastomeric layer 708. It should be noted that the configuration of the elastomeric layer 708 and the incompressible layer 709 as explained here is also provided near the cathode flow field. Further, as explained in the preceding paragraphs, the elastomeric layer 708 acts as a sealant to seal the surface of the anode flow field. A thickness of the elastomeric layer 708 is 10 to 100 microns. Further, a hardness of the elastomeric layer 708 is 10 to 60 Shore A. The elastomeric layer 708 is made of a platinum cured silicone or fluorosilicone or ethylene propylene diene monomer (EPDM). The incompressible layer 709 acts as a shim to control the optimum compression of gas diffusion layers (GDLs) and to support the elastomeric layer 708. The membrane 405 interfaces with two incompressible layers 709. A thickness of the incompressible layer 709 varies depending on a type of gas diffusion layers (GDLs). Further, 70 to 95% of thickness of the gas diffusion layers amounts to a total thicknesses of the incompressible layer 709 and the elastomeric layer 708. The incompressible layer 709 is made of polyethylene terephthalate referred to as simply polyester. It should be noted that the incompressible layer 709 also be made of other engineering plastics, which are similar materials that have properties of mechanical strength and corrosion tolerance such as polyethylene, polysulfone, polyimide, polypropylene, polyether ether ketone, polycarbonate, polyetherimide. The materials for the incompressible layer 709 are incompressible under 100° C. and 700 kPa. With the aforementioned configuration of the elastomeric layer 708 and the incompressible layer 709 on each of the anode and the cathode flow field, the compression of at least the gas diffusion layers can be controlled. Further, with the above allows for proper sealing, and improvement of durability in fuel cell stacks.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A composite gasket to provide sealing and to control a swelling of at least a plurality of gas diffusion layers in a fuel cell, said gasket comprising:
a first incompressible layer provided near an anode flow field;
a second incompressible layer provided near a cathode flow field;
a first elastomeric layer provided in between said first incompressible layer and said anode flow field; and
a second elastomeric layer provided between said second incompressible layer and said cathode flow field.

2. The gasket as claimed in claim 1, wherein said first and second incompressible layers are configured to receive a portion of a membrane electrolyte there between.

3. The gasket as claimed in claim 2, wherein
said first elastomeric layer is configured to be in direct contact with a plurality of lands defined on said anode flow field; and
said second elastomeric layer is configured to be in direct contact with a plurality of lands defined on said cathode flow field.

4. The gasket as claimed in claim 3, wherein each of said first and second elastomeric layer is made from one of a platinum cured silicone, a fluorosilicone and ethylene propylene diene monomer (EPDM).

5. The gasket as claimed in claim 4, wherein a thickness of each of said first and second elastomeric layer is in the range of 10 to 100 microns.

6. The gasket as claimed in claim 5, wherein a hardness of each of said first and second elastomeric layer is in the range of 10 to 60 shore A.

7. The gasket as claimed in claim 3, wherein each of said first and second incompressible layer is made from one of polyethylene, polysulfone, polyimide, polypropylene, polyether ether ketone, polycarbonate and polyetherimide.

8. The gasket as claimed in claim 3, wherein each of said first and second incompressible layer is incompressible under 100° C. and 700 kPa.

9. The gasket as claimed in claim 7, wherein each of said first and second incompressible layer is made of polyethylene terephthalate.

10. The gasket as claimed in claim 1, wherein a thickness of said gasket is in the range of 70-95% of a thickness of the gas diffusion layer.
